(19) United States
(12) Patent Application Publication
(10) Pub. No.: US 2011/0286131 A1
(43) Pub. Date: Nov. 24, 2011

(54) DIRECTING WINDAGE ESTABLISHED BY A ROTATING DISC

(75) Inventors: Swee How Alvin Teo, Singapore (SG); JuiJing Lim, Singapore (SG); YongJie Tang, Singapore (SG); Suwandi Chendekiawan, Singapore (SG); BoonSeng Ong, Singapore (SG); Niroot Jierapipatanakul, Singapore (SG); Xiong Liu, Singapore (SG)

(73) Assignee: SEAGATE TECHNOLOGY LLC, Scotts Valley, CA (US)

(21) Appl. No.: 12/783,482

(22) Filed: May 19, 2010

(51) Int. Cl. G11B 17/32; F04D 23/00

(52) U.S. Cl. 360/224; 415/182.1; G9B/17.061

(57) ABSTRACT

An apparatus and associated method for directing windage involves a body defining an aperture. A fastener is operably disposed in the aperture and is selectively engageable with a fixed support member between a first mode permitting rotation of the body around the fastener longitudinal axis, and a second mode affixing the body in place to the support member at a desired rotational orientation. A shroud depends from the body and is sized at a distal end for an operable mating relationship adjacent an arcuate edge of a disc that is rotatable around a disc axis. The shroud distal end is operably disposed a first distance from the fastener longitudinal axis in a direction of a plane including the fastener longitudinal axis and the disc axis. A leading edge of the shroud, with respect to a direction of windage established by disc rotation, is disposed a second distance from the fastener longitudinal axis that is the same or less than the first distance from the fastener longitudinal axis.

### SUMMARY

In some embodiments an apparatus is provided having a body defining an aperture. A fastener is operably disposed in the aperture and is selectively engageable with a fixed support member between a first mode permitting rotation of the body around the fastener longitudinal axis, and a second mode affixing the body in place to the support member at a desired rotational orientation. A shroud depends from the body and is sized at a distal end for an operable mating relationship adjacent an arcuate edge of a disc that is rotatable around a disc axis. The shroud distal end is operably disposed a first distance from the fastener longitudinal axis in a direction of a plane including the fastener longitudinal axis and the disc axis. A leading edge of the shroud, with respect to a direction of windage established by disc rotation, is disposed a second distance from the fastener longitudinal axis that is the same or less than the first distance from the fastener longitudinal axis.

In some embodiments a method is provided that includes the steps of obtaining a windage directing apparatus having a body defining an aperture, a fastener operably disposed in the aperture, and a shroud depending from the body; aligning the fastener to a fixed support member disposed adjacent a rotatable disc; after the aligning step, rotating the body with respect to the fastener to an operable rotational orientation where a distal end of the shroud is disposed in mating relationship adjacent an arcuate edge of the rotatable disc to operably direct windage established by rotation of the planar surface; and after the rotating step, securing the fastener to affix the body in place to the support member at the operable rotational orientation.

In some embodiments a data storage device is provided having a data transfer member selectively moveable in a data transfer relationship with a rotatable storage disc, and means for directing windage established by rotation of the rotatable storage disc that can be operably installed in the data storage device after the rotatable storage disc has been operably installed in the data storage device.

### BRIEF DESCRIPTION OF THE DRAWINGS

FIG. 1 is a top view depiction of a data storage device suited for use in practicing the embodiments of the present invention.

FIG. 2 depicts a data storage device constructed in accordance with embodiments of the present invention.

FIG. 3 is an isometric depiction of the windage directing apparatus in the data storage device of FIG. 2.

FIG. 4 is a partial cross-sectional depiction of the windage directing apparatus of FIG. 3.

FIG. 5 is a cross-sectional depiction of the windage directing apparatus of FIG. 3 in a first mode of the fastener in which the body is selectively rotatable with respect to the fastener.

FIG. 6 is a cross-sectional depiction of the windage directing apparatus of FIG. 3 in a second mode of the fastener in which the body is affixed in place to the support member.

FIG. 7 is another partial cross-sectional depiction of the windage directing apparatus and discs of FIG. 3.

FIG. 8 is an enlarged top view depiction of the windage directing apparatus of FIG. 3.

FIG. 9 is a view similar to FIG. 7 but depicting a windage directing apparatus that is constructed in accordance with alternative embodiments of the present invention.

FIG. 10 depicts another data storage device that is constructed in accordance with embodiments of the present invention.

FIG. 11 is an enlarged top view depiction of the windage directing apparatus of FIG. 10.

FIG. 12 is a flowchart depicting steps in a method of DIRECTING WINDAGE in accordance with embodiments of the present invention.

### DESCRIPTION

Disc drive data storage devices are all the time becoming more commonly used in portable systems having onboard processing systems that are by nature of application subjected to random movement and vibration. A disc drive stores data that must be readily available to a user regardless of the use. Generally, a disc drive has one or more rotating data storage discs in a data transfer relationship with a rotating actuator that moves a data transfer member in a close mating relationship with the discs.

Consumer demands have continually pushed the industry to provide more capacity in a smaller-size package. Those demands necessarily require smaller spacing between the actuator and the data storage discs, and higher areal storage density requiring more precise positioning of the actuator relative to the data storage discs. These requirements give rise to problems of increased sensitivity of positional error due to non-operating mechanical shocks and windage established by surfaces of the rotating discs. As for shocks, predominant failure modes in modern disc drives have been found to include damage to the surfaces of the discs and damage to the actuator arms as a result of mechanical shocks encountered during the shipping, handling, and portable use of the data storage devices. As for windage, the outwardly spiraling fluidic flow can create turbulence that positionally displaces the data transfer members and the disc edges (disc flutter).

More particularly on shocks, computer modeling of particular disc drives has revealed that one primary cause of interference between discs and actuator arms is the first mechanical bending mode of the discs, which has been found to cause a significant portion of the relative motion between the data storage discs and the actuator. The bending mode is generally dependent upon the material, diameter and thickness of the data storage discs, and these factors are not readily modified in a disc drive design.

More particularly on windage, as the disc assembly is operably rotated at high speed, the fluid (such as air or an inert gas) adjacent to the spinning disc (or discs) is caused to move as well. This moving fluidic stream, or referred to as “windage” herein. spirals outwardly from the disc center and eventually moves between the rotating disc and the data transfer member, creating an air bearing, referred to as “flying” the data transfer member over the disc surface. The windage is thus generally a desirable feature of the disc drive. However, the windage established by rotating the disc, as it passes by the data transfer member, the supporting arms, and the fixed structures surrounding the disc, can also cause undesirable vibrations in the disc drive due to turbulence and/or friction. Flow perturbations cause the disc and/or data transfer members and supporting arms to vibrate, making precision tracking operations difficult. Head positioning via servo control feedback is limited by predictable positional alignment of the transducer with recorded servo information on the disc.

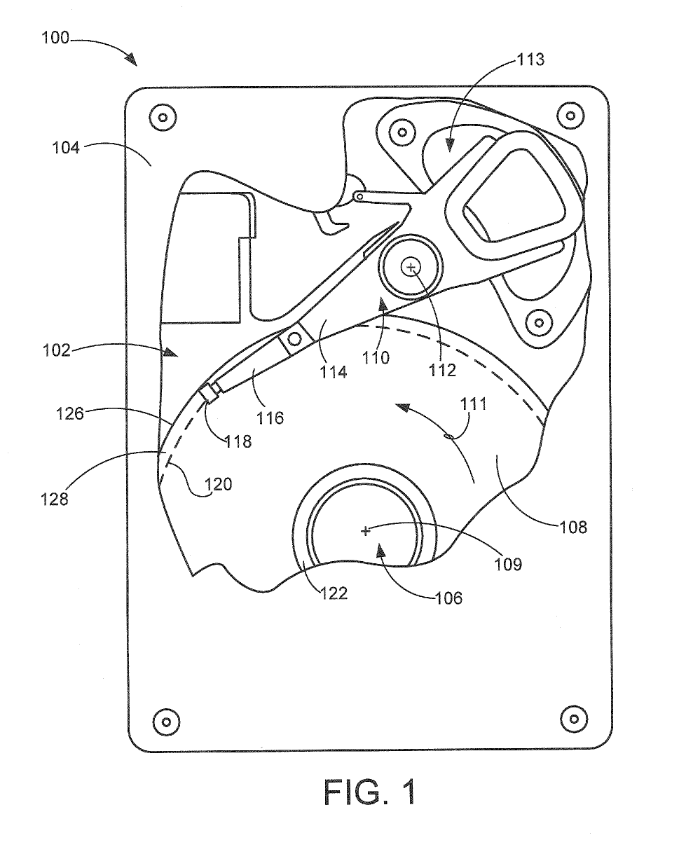

Turning now to the drawings collectively and now more particularly to FIG. 1, shown therein is a top view of a data storage device 100 that is constructed in accordance with embodiments of the present invention. The device 100 includes a base 102, to which various disc drive components are mounted, and a cover 104 (shown partially cutaway), which cooperates with the base 102 to provide a sealed internal environment for the device 100.

Mounted to the base 102 is a spindle motor (shown generally at 106) to which one or a plurality of data storage discs 108 (a plurality referred to as a disc stack) are mounted for rotation at a high speed around a disc axis 109 and in a direction indicated by reference arrow 111. Adjacent the discs 108 is an actuator 110 which is pivoted around an actuator axis 112, such as by a voice coil motor 113. The actuator 110 includes a number of arms 114, one per each disc recording surface, supporting suspensions 116 that, in turn, support data transfer members 118. As such, the data transfer members 118 are selectively positioned with respect to data tracks (only one outermost track 120 depicted diagrammatically) of the discs 108 in order to read data from and write data to the tracks.

The data transfer members 118 are selectively moved within a data recording surface between an innermost radial location 122 and the outermost radial storage location 120. In these illustrative embodiments the innermost radial location is an annulus of disc space that is not used for storing data, but is rather a landing space upon which the data transfer member 118 can be parked when the device 100 is shut down or switched to a reduced power mode. In alternative equivalent embodiments the innermost radial location can be an innermost data track, with the landing zone being elsewhere such as a landing ramp beyond the outer edge 126 of the disc 108.

Also in these illustrative embodiments between the outermost radial storage location 120 and the outer edge 126 of the disk 108 there is another annulus of non-storage space 128. The non-storage space 128 provides a guard band from the disc edge 126 where fluidic turbulence and/or disc flutter create data transfer member 118 positional fluctuations of a magnitude greater than that which facilitates reliable data transfer activity.

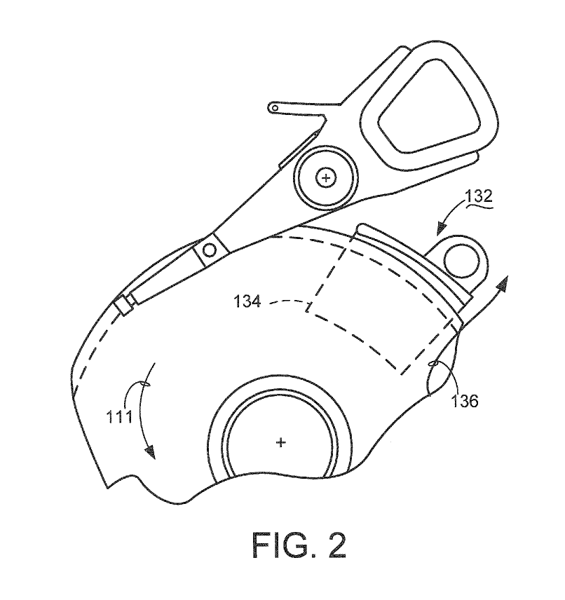

FIG. 2 depicts the actuator 110 and a disc stack having a pair of rotatable discs 108. A windage directing apparatus 132 is disposed upstream of the actuator 110, with respect to the direction 111 of disc 108 rotation, to function as a windage stripper that directs windage away from the actuator 110. The windage directing apparatus 132 has a fin 134 sandwiched in the gap between the discs 108. The fin 134 creates a localized flow restriction that strips away, or diverts, a portion 136 of the outwardly spiraling windage away from the actuator 110. The comparatively small portion of the windage that passes through the windage directing apparatus 132 is slowed and straightened so as to not be turbulent when it impinges the actuator 110 immediately downstream of the windage directing apparatus 132.

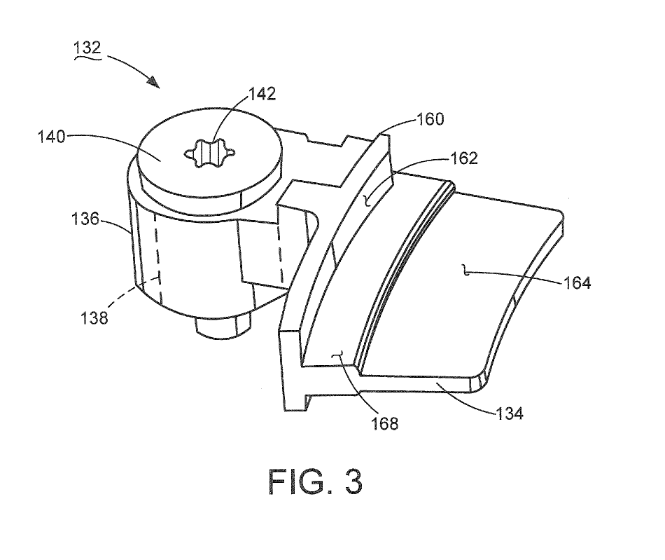

FIG. 3 is an isometric depiction of the windage directing apparatus 132 of FIG. 2. The windage directing apparatus 132 has a body 136 defining an aperture 138 into which a fastener 140 is disposed. In these illustrative embodiments the fastener 140 defines a driving feature 142 matching a tool (not shown) used for attaching the fastener to the base 102 or other support member supported ultimately by the base 102.

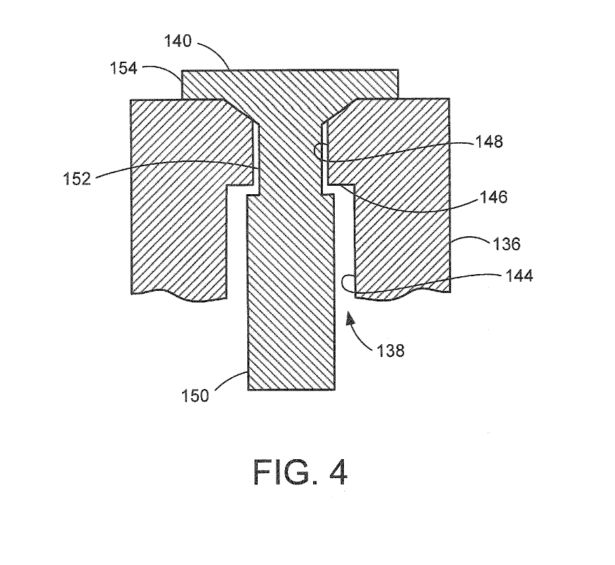

The fastener 140 preferably is operably locked to the body 136 so that the two can be picked and placed unitarily; that is, either the fastener 140 or the body 136 can be picked and placed to the base 102 during assembly and the other will likewise be unitarily picked and placed as a result. FIG. 4 is a cross-sectional depiction of illustrative embodiments of locking the fastener 140 to the body 136. The body 136 defines a longitudinal bore 144 and a protuberant member 146 defining a comparatively reduced bore 148. The fastener 140 defines a longitudinal diameter 150 and a comparatively reduced diameter 152 that is longitudinally aligned with the protuberant member 146. In some embodiments the longitudinal diameter 150 can be a threaded portion and the reduced diameter 152 can be an undercut formed between the threaded portion and the head 154 of the fastener 140. In those embodiments the threaded portion can be made of a comparatively hard material, such as a metal, and the body 136 can be made of a comparatively soft material, such as a polymer, permitting the fastener 140 to be threaded into the protuberant member 146 and longitudinally advanced until the undercut receivingly engages the protuberant member 146. At that point the longitudinal displacement of the fastener 140 is limited, preventing it from being withdrawn from the aperture 138. The fastener 140 is thus said to be locked to the body 136 because they can effectively be picked and place in unison.

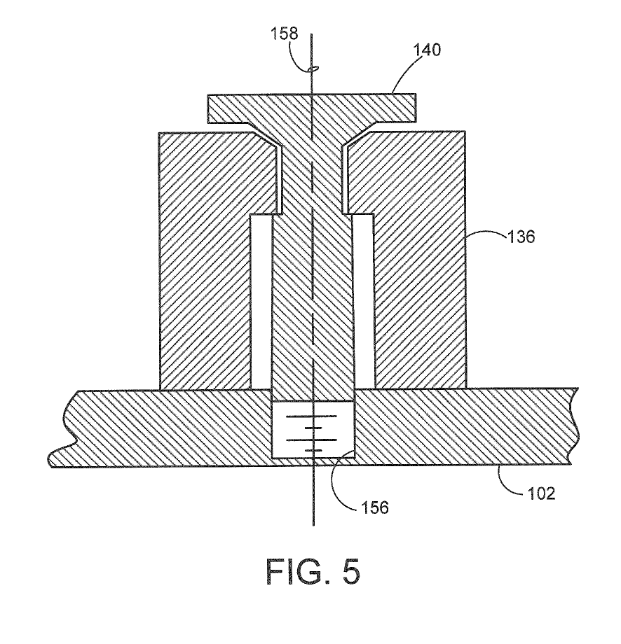

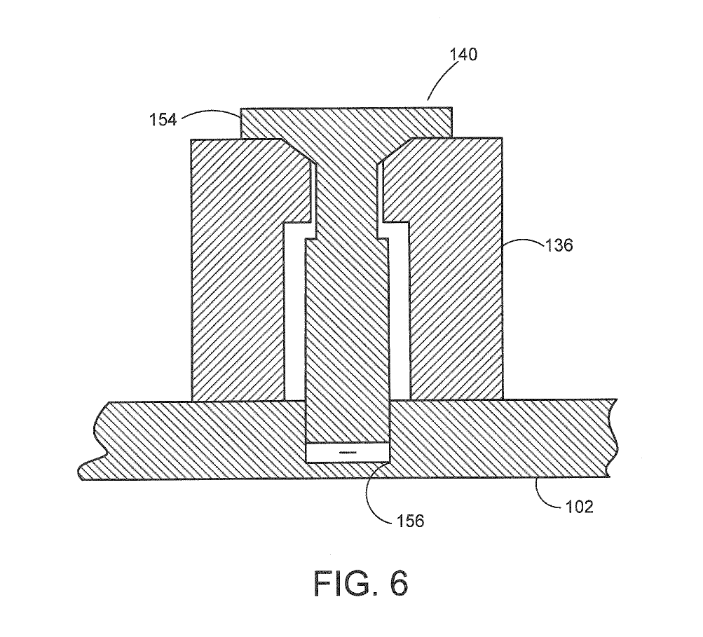

FIGS. 5 and 6 depict the fastener 140 being selectively engageable with the base 102, a fixed support member, between a first mode and a second mode, respectively. Staying with the aforementioned illustrative embodiments in which the fastener 140 is a threaded type fastener, FIG. 5 depicts the first mode in which the body 136 is resting upon the base 102, if due to being placed there or if only due to the force of gravity. The fastener 140 is aligned with and has just made a preliminary threading engagement with an attachment feature, in this case a threaded aperture 156, in the base 102. In this first mode the body 136 is loosely constrained, permitting rotation of the body 136 around the fastener's longitudinal axis 158. This permits rotationally positioning the body 136 around the fastener 140 to a desired rotational orientation.

At the desired rotational orientation, FIG. 6 depicts the second mode of the fastener 140 whereby it has been threadingly advanced into the threaded aperture 156 and torqued to a predetermined value to constrain the body 136 in compression between the head 154 and base 102 and thereby affix the body 136 in place to the base 102 at the desired rotational orientation.

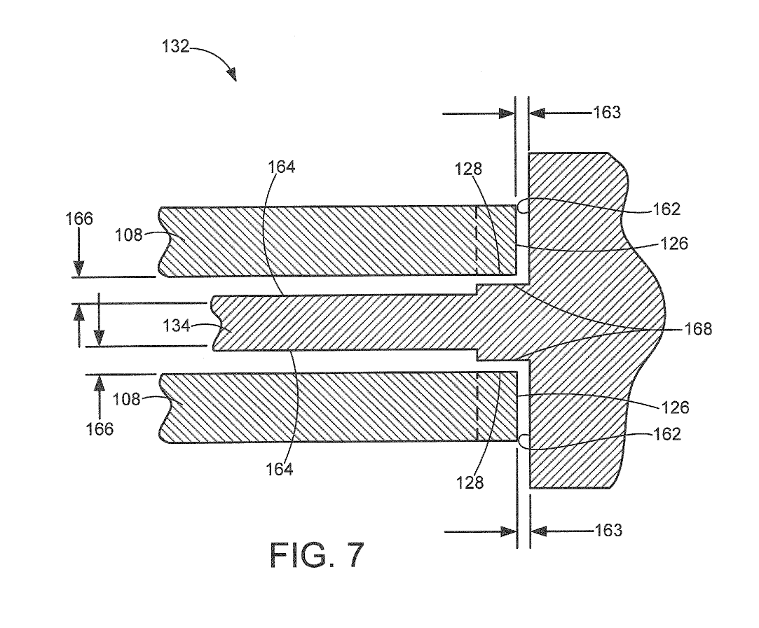

Returning now to FIG. 3, the windage directing apparatus 132 further has a shroud 160 depending from the body 136 and sized at a distal end 162 thereof for an operable mating relationship adjacent the arcuate edge 126 (FIG. 1) of the disc 108. Preferably, the distal end 162 is arcuate in order to provide a substantially constant spatial separation between it and the edge 126 of the disc 108, that separation denoted by reference number 163 in FIG. 7. That close mating constant spatial separation 163 advantageously prevents shedding vortices in the windage on opposing sides of the disc 108 from coupling to create circular eddies at the edge 126. Otherwise, without the shroud 160, such coupling can aerodynamically excite the disc 108 at its edge 126 causing nonrepeatable runout that is sometimes referred to as disc flutter.

The fin 134 depends from the distal end 162 of the shroud 160 and has opposing surfaces 164 each operably providing a mating relationship adjacent the planar surface of the respective disc 108. Preferably, the mating relationship is a substantially constant spatial separation between the fin surface 164 and the corresponding data recording surface of the disc 108, that separation denoted by reference number 166 in FIG. 7.

Staying with FIG. 7, the fin 134 supports opposing snubbers 168 that are sized to extend between the fin surface 164 and the disc 108 surface in order to operably contactingly engage the disc 108 to prevent the disc 108 from contactingly engaging the fin surface 164 as a result of a deflection of the disc 108. The snubbers 168 extend orthogonally from the shroud surface 162 only so far as to not extend beyond the annular nonrecording surface 128 of the respective disc 108, so that the deflection can cause localized contact between the snubber 168 and the disc 108 only within the nonrecording surface 128. Preferably, the body 136, the shroud 162, the fin 134, and the snubber 168 are unitarily constructed as a single component requiring no subassembly.

The windage directing apparatus 132 is constructed to permit merging the shroud 162 and fin 134 with an existing disc stack. In other words, the windage directing apparatus 132 of the present embodiments advantageously avoids any need to incrementally stack the lower disc 108 in FIG. 7, then the windage directing apparatus 132, then the upper disc 108. Rather, the windage directing apparatus 132 is configured to permit placing it in the disc drive and then rotating the body 136 to operably position the shroud 160 and interleave the fin 134 with the discs 108.

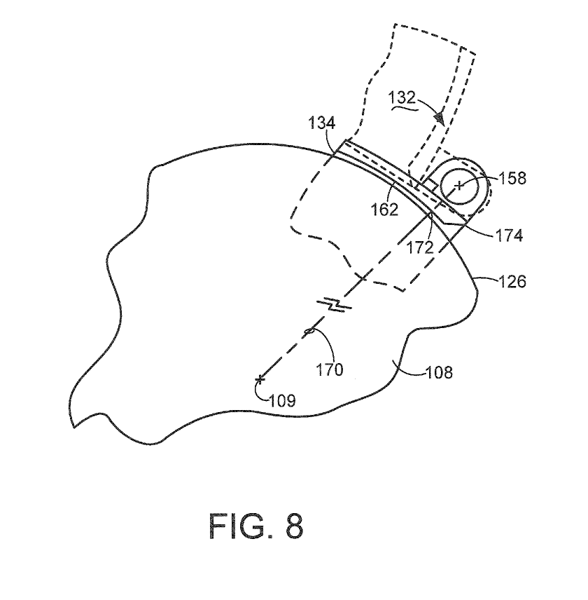

FIG. 8 is an enlarged top view of the windage directing apparatus 132 depicting the initial rotational orientation (broken lines) and depicting the operable rotational orientation (solid lines) where it is affixed to the base 102 as described above. In the operable rotational orientation reference is made to a plane denoted by reference number 170 that includes both the disc axis 109 (FIG. 1) and the fastener longitudinal axis 158. Respecting that reference plane 170, the shroud surface 162 intersects the plane 170 at reference number 172. The distance from the fastener longitudinal axis 158 to the shroud surface 162 along the plane 170, or the radius at reference 172, is sized to clear the edge 126 of the disc 108 as the windage directing apparatus 132 is rotated counter-clockwise as depicted from the initial rotational orientation, where the fin 134 is entirely outside the disc stack, to the operable rotational orientation where the shroud 160 is in place and the fin 134 is merged in the disc stack. For the same reason, the distance from the fastener longitudinal axis 158 to the leading edge 174 of the shroud surface 162, with respect to the direction of the windage, is sized to be the same or less than the radius at reference 172. That permits rotating the leading edge 174 into the operable rotational orientation depicted in FIG. 8.

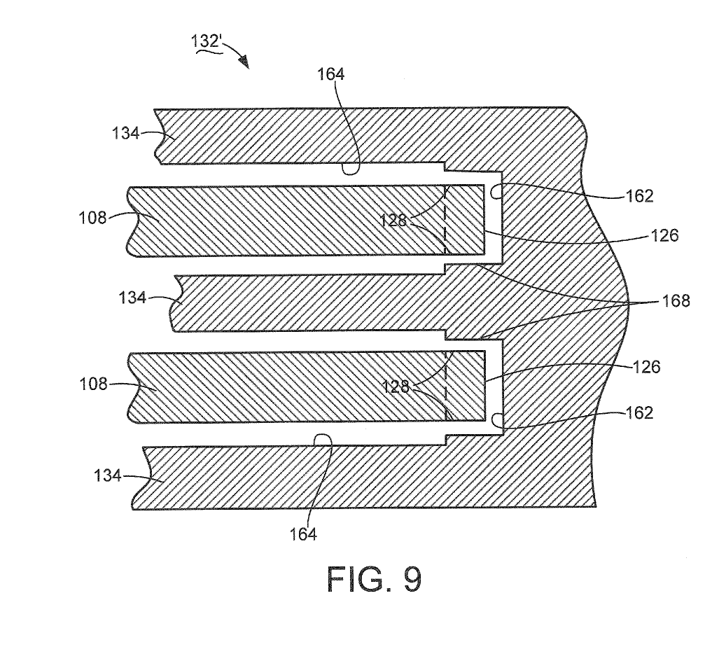

The embodiments above have contemplated the windage directing apparatus 132 having one fin 134 operably disposed between the discs 108 in a two disc stack. FIG. 9 depicts alternative embodiments that contemplate the same disc stack but having a windage directing apparatus 132′ also having, in addition to the fin 134 between the discs 108, fins 134 outside the discs 108 likewise defining fin surfaces 164 sized for an operable mating relationship adjacent the opposing planar surfaces of the respective discs 108. Like before, the operable mating relationship is preferably a substantially constant spatial separation between the fin surface 164 and the data recording surface of the respective disc. Also as before, the additional fins 134 in FIG. 9 support snubbers 168 to operably contactingly engage the disc 108 to prevent the disc 108 from contactingly engaging the fin surface 164 as a result of a deflection of the rotatable disc 108, and each additional snubber 168 is sized so that the deflection can cause localized contact between the snubber 168 and the disc 108 only within the nonrecording surface 128.

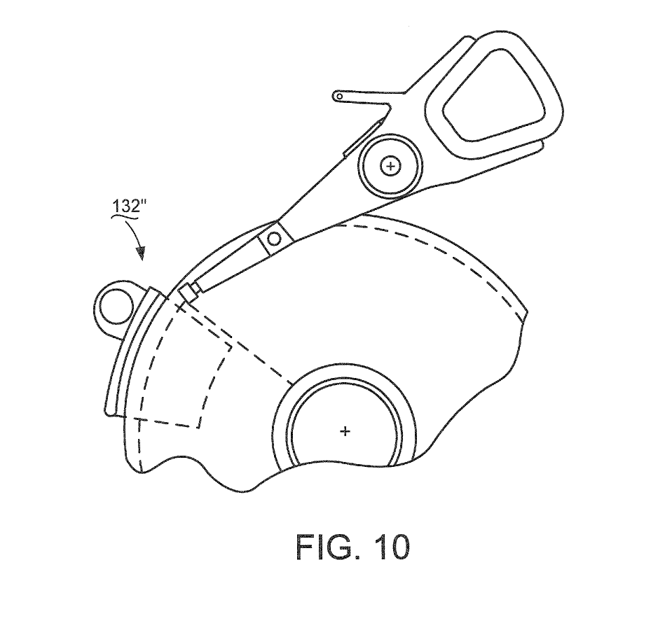

FIG. 10 is a view similar to FIG. 2 but depicting alternative embodiments in which a windage directing apparatus 132″ is operably positioned immediately downstream of the actuator 110 to function as a windage dam. By substantially filling the space downstream of the data transfer member 118, the fin 134 reduces aerodynamic excitation effects of the windage on the actuator 110. For example, the fin 134 decreases the Reynolds shear stresses acting on the actuator 110 by decelerating the windage mean flow. Also, the fin 134 acts in the manner of a flow straightener device, substantially like a honeycomb device, to establish fully developed windage flow conditions, thereby suppressing the three-dimensional wake formed downstream of the actuator 110. Thus, as the aerodynamic excitation on the actuator 110 is reduced, such as for the reasons above, then the torque disturbances on the desired actuator 110 movement are reduced.

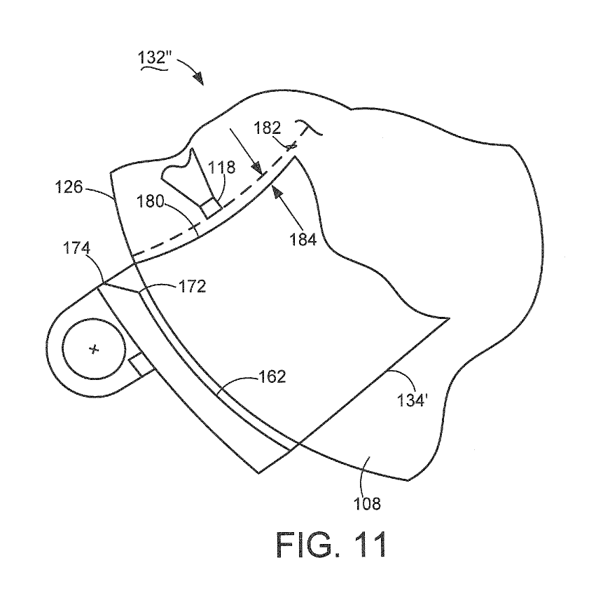

FIG. 11 is a top view of the windage directing apparatus 132″ of FIG. 10 with the top disc 108 removed for clarity to reveal the fin 134′. The leading edge 180 of the fin 134′ defines an operably mating relationship adjacent a travel path 182 of the data transfer member 118 as it traverses the data recording surface of the disc 108. Preferably, the leading edge 180 is arcuate so that the operable mating relationship is a substantially constant spatial separation denoted by reference number 184 between the leading edge 180 and the travel path 182.

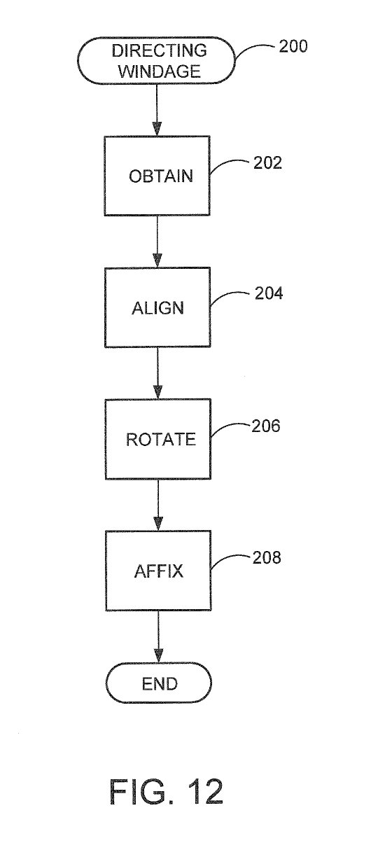

FIG. 12 is a flowchart depicting steps in a method 200 for DIRECTING WINDAGE in accordance with embodiments of the present invention. The method 200 begins in block 202 with obtaining a windage directing apparatus constructed in accordance with the present embodiments, such as for being employed as the stripper depicted in FIG. 2 or the dam depicted in FIG. 10. Generally, in either case, the windage directing apparatus has a body defining an aperture, a fastener operably disposed in the aperture, and a shroud depending from the body. Preferably, the fin also supports a snubber that is sized to operably contactingly engage the disc to prevent the disc from contactingly engaging the fin surface as a result of a deflection of the disc. In that event the disc can have a data recording surface and an annular band of nonrecording surface extending radially inwardly from the edge of the disc, and the snubber can be sized so that the deflection can cause localized contact between the snubber and the rotatable disc only within the nonrecording surface.

The method 200 continues in block 204 with aligning the fastener with an attachment feature of the support member. In the disclosed illustrative embodiments, for example and not by way of limitation, the attachment feature is a threaded aperture formed in the base. In that event the aligning step includes beginning the threading engagement of the fastener into the threaded aperture, but only to the extent that the body remains rotatable in relation to the fastener.

After the aligning step, in block 206 the body is rotated with respect to the fastener to an operable rotational orientation where a distal end of the shroud is disposed in the described mating relationship adjacent the arcuate edge of the disc in order to operably direct windage established by rotation of the disc. Preferably, for example and not by way of limitation, the distal end of the shroud can be arcuate to provide a constant spatial separation as described herein. Further, the operable rotational orientation preferably places the fin in a mating relationship adjacent the data recording surface of the disc, such as the constant spatial separation described herein.

Finally, after the rotating step, in block 208 the fastener is secured to affix the body in place to the support member at the operable rotational orientation. In the illustrative embodiments of the threaded fastener and attachment feature, the affixing step can include torquing the threaded members to a predetermined torque value to ensure the integrity of the affixed rotational orientation.

Generally, the described embodiments contemplate a data storage device having a data transfer member (such as 118) selectively moveable in a data transfer relationship with a rotatable storage disc (such as 108), and means for directing windage (such as 132, 132′, 132″) established by rotation of the rotatable storage disc that can be operably installed in the data storage device after the rotatable storage disc has been operably installed in the data storage device. For purposes of this description, including the meaning of the claims, the meaning of “means for directing windage” encompasses the disclosed structure and structural equivalents thereof that can be merged with a disc or disc stack after the disc/stack has been installed to the base. The rotational capability of the described embodiments, in conjunction with the sizing of the shroud to permit rotation in close proximity to the edge of the disc, is included in the disclosed structure that gives meaning to the term “means for directing windage.” The term “means for directing windage” expressly does not encompass alternative solutions that do not provide a shroud in close mating relation to the disc edge, or that are incapable of being installed by merging with an existing disc stack in the data storage device.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts and values for the described variables, within the principles of the present embodiments to the full extent indicated by the broad general meaning of the terms in which the appended claims are expressed.

What is claimed:

1. An apparatus comprising:
a body defining an aperture;
a fastener operably disposed in the aperture and selectively engageable with a fixed support member between a first mode permitting rotation of the body around the fastener longitudinal axis, and a second mode affixing the body in place to the support member at a desired rotational orientation; and
a shroud depending from the body and sized at a distal end for an operable mating relationship adjacent an arcuate edge of a disc that is rotatable around a disc axis, the shroud distal end operably disposed a first distance from the fastener longitudinal axis in a direction of a plane including the fastener longitudinal axis and the disc axis, and a leading edge of the shroud with respect to a direction of windage established by disc rotation disposed a second distance from the fastener longitudinal axis that is the same or less than the first distance from the fastener longitudinal axis.

2. The apparatus of claim 1 wherein the operable mating relationship is characterized as a first operable mating relationship, further comprising a fin depending from the shroud distal end and defining a fin surface sized for an operable second mating relationship adjacent a planar surface of the rotatable disc.

3. The apparatus of claim 2 further comprising a snubber supported by the fin sized to operably contactingly engage the disc to prevent the disc from contactingly engaging the fin surface as a result of a deflection of the disc.

4. The apparatus of claim 3 wherein the disc has a data recording surface and an annular band of nonrecording surface extending radially inwardly from the edge, the snubber sized so that the deflection can cause localized contact between the snubber and the disc only within the nonrecording surface.

5. The apparatus of claim 4 wherein a leading edge of the fin defines an operable third mating relationship adjacent a travel path of a data transfer member operably traversing the recording surface.

6. The apparatus of claim 5 wherein the leading edge of the fin is arcuate and the third mating relationship is characterized by a substantially constant spatial separation between the leading edge of the fin and the travel path of the data transfer member.

7. The apparatus of claim 1 wherein the shroud is arcuate and the operable mating relationship is characterized by a substantially constant spatial separation between the distal end of the shroud and the edge of the disc.

8. The apparatus of claim 2 wherein the second mating relationship is characterized by a substantially constant spatial separation between the fin surface and the planar surface of the disc.

9. The apparatus of claim 1 wherein the fastener is operably locked to the body in the aperture, thereby limiting fastener longitudinal displacement to prevent the fastener from being withdrawn from the aperture in either longitudinal direction.

10. The apparatus of claim 9 wherein the body defines a protuberant member extending into the aperture and the fastener defines an undercut sized to receivingly engage the protuberant member.

11. The apparatus of claim 3 wherein the body, shroud, fin, and snubber are unitarily constructed.

12. The apparatus of claim 1 wherein the fastener comprises a threaded fastener that operably engages a threaded attachment feature in the support member.

13. The apparatus of claim 3 wherein the fin is characterized as a first fin, and further comprising a second fin depending from the shroud distal end and defining a second fin surface sized for an operable fourth mating relationship adjacent an opposing planar surface of the disc.

14. The apparatus of claim 13 wherein the fourth mating relationship is characterized by a substantially constant spatial separation between the second fin surface and the opposing planar surface of the disc.

15. The apparatus of claim 13 wherein the opposing side of the disc has another data recording surface and another annular band of nonrecording surface extending radially inwardly from the edge of the disc, and wherein the snubber is characterized as a first snubber, further comprising a second snubber supported by the second fin to operably contactingly engage the disc to prevent the disc from contactingly engaging the second fin surface as a result of another deflection of the rotatable disc, the second snubber sized so that the deflection can cause localized contact between the second snubber and the disc only within the another nonrecording surface.

16. A method comprising:
obtaining a windage directing apparatus having a body defining an aperture, a fastener operably disposed in the aperture, and a shroud depending from the body;
aligning the fastener to a fixed support member disposed adjacent a rotatable disc;
after the aligning step, rotating the body with respect to the fastener to an operable rotational orientation where a distal end of the shroud is disposed in a mating relationship adjacent an arcuate edge of the rotatable disc to operably direct windage established by rotation of the planar surface; and
after the rotating step, securing the fastener to affix the body in place to the support member at the operable rotational orientation.

17. The method of claim 16 wherein the obtaining step is characterized by the fastener being operably locked to the body in the aperture.

18. The method of claim 16 wherein the mating relationship is characterized as a first mating relationship, the obtaining step is characterized by the windage directing apparatus further having a fin depending from a distal end of the shroud, and the rotating step is characterized by a surface of the fin being disposed in a second mating relationship adjacent a planar surface of the rotatable disc at the operable rotational orientation.

19. The method of claim 16 wherein the obtaining step is characterized by the fastener being a threaded feature and the support member having another threaded feature, the aligning step is characterized as partially threadingly engaging the threaded features together before the rotating step, and the securing step is characterized by torquing the threaded features together to a predetermined torque value.

20. The method of claim 18 wherein the obtaining step is characterized by the shroud being arcuate and the first mating relationship being a substantially constant spatial separation between the distal end of the shroud and the edge of the disc, and the second mating relationship being a substantially constant spatial separation between the fin surface and the planar surface of the disc.

21. The method of claim 18 wherein the obtaining step is characterized by the fin supporting a snubber that is sized to operably contactingly engage the disc to prevent the disc from contactingly engaging the fin surface as a result of a deflection of the disc.

22. The method of claim 21 wherein the obtaining step is characterized by the disc having a data recording surface and an annular band of nonrecording surface extending radially inwardly from the edge of the disc, and the snubber being sized so that the deflection can cause localized contact between the snubber and the rotatable disc only within the nonrecording surface.

23. A data storage device, comprising:
a data transfer member selectively moveable in a data transfer relationship with a rotatable storage disc stack; and
means for directing windage established by rotation of the disc stack that can be operably merged with the disc stack in the data storage device after the disc stack has been operably installed in the data storage device.
